(19) United States
(12) Patent Application Publication
(10) Pub. No.: US 2005/0078280 A1
(43) Pub. Date: Apr. 14, 2005

(54) Arrangement for correction of the visual depiction of image information

(76) Inventors: Gerd Rieche, Jena (DE); Nico Correns, Weimar (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/962,175

(22) Filed: Oct. 7, 2004

(30) Foreign Application Priority Data
Oct. 8, 2003 (DE) 103 47 388.2

(51) Int. Cl. G03B 21/28

(52) U.S. Cl. 353/69

(57) ABSTRACT

The invention relates to an arrangement for the correction of the visual depiction of image information on a projection surface, such as a projection wall, comprising a processor for the purpose of providing the image information, which is connected to a projector as well as a sensor unit for capturing image data, which can be captured by the processor and converted to correction data. According to the invention, the sensor unit consists of a color sensor and/or a sensor for capturing geometric image data, and is integrated into the projector.

The invention relates to an arrangement for the correction of the visual depiction of image information on a projection surface, such as a projection wall, comprising a processor, for the purpose of providing the image information, which is connected to a projector and a sensor unit for capturing image data, which can be captured by the processor and converted to correction data.

### BACKGROUND OF THE INVENTION

As is known, the settings for image information are changed by means of control elements provided on the projector, which is often disadvantageous during presentations.

To correct deterioration in color image displays on a projection surface, a solution is proposed, in EP 1 150 159, in which the image data stored on a computer and representing image information in a color space, are supplied to a projection device in the form of a video stream. This then generates corresponding optical signals and projects them onto a projection surface. Adjacent to the projector is a light metering device, which captures either the light emitted by the projector or the light reflected from the projection surface and supplies the metering data generated in this process to profile development software for the purpose of image correction.

A disadvantage of such arrangements is that, in addition to the projector, a device oriented to the projection surface must be installed, making the entire projection technology highly complex and cost-intensive. In addition, such solutions can only be used to precisely adjust or correct influences of the properties of the projection surface, such as those of a screen, or of light conditions at the projector location.

### SUMMARY OF THE INVENTION

Based on the above, the object of the invention is to provide an arrangement for correction of the visual depiction of image information on a projection surface, with which, in a relatively simple manner and without additional technical equipment complexity, the image information depicted by a projector is, with regard to the light and color parameters, as well as the geometry on the projection surface, optimally adjustable for the viewer or correctable as a factor of changes specific to the surrounding environment.

According to the invention, this objective is solved by an arrangement of the type mentioned initially in that the sensor unit consists of a color sensor and/or a sensor for capturing geometric image data and is integrated into the projector.

Due to the direct integration of the sensor unit or sensor units for image data correction into the projector, there is no need to install additional measuring systems that are user-unfriendly.

Advantageously, the sensor unit is oriented in the direction of the projection beam path and/or in the direction of the light reflected by the project surface for the purpose of capturing metering light in this context. Here a spectrometer is provided for detecting the parameters of the true color depiction, brightness, and color of the projection wall, as well as brightness and ambient light.

The removal of the metering light for the sensor unit from directly within the projection beam path is a relatively simple embodiment of the arrangement according to the invention. However, the metering results are often insufficient because the conditions influencing the image data, in conjunction with the project surface (projection wall), as well as the illumination of the space are not measured. In this regard, it is more advantageous to derive the metering light for the sensor unit from the light reflected by the projection wall. Both possibilities are also conceivable.

This can be achieved by using an aspherical lens connected upstream from the sensor unit and located adjacent to the optic of the projection lens.

Another option is to feed the light reflected by the projection surface directly through the optic of the projection lens to the sensor unit. With this option, no additional optical elements would be required.

Another advantageous embodiment of the arrangement according to the invention consists in providing a sensor with two-dimensional, matrix-like detector elements for detection of the parameters of image sharpness and linear distortion. These could be CCD, CMOS or PDA detector elements, for example.

Through the projection of a template, such as a pattern provided with stripes, the image sharpness at the edges of the stripes can be determined using these detector elements, so that correction of the image data by means of a downstream process unit becomes possible.

In addition, trapeze corrections (keystone errors) based on the Scheimpflug principle or using microfine Fresnell lenses with image reversal can be performed through these detector elements. This is especially advantageous because such corrections by means of tilting projection surfaces can only be completed at a high cost.

The arrangement according to the invention is described in greater detail in the following.

### DESCRIPTION OF THE FIGURES

FIG. 1 depicts a simplified view of the arrangement according to the invention, and

FIG. 2 depicts a sensor unit for capturing the light reflected by the projection surface.

### DETAILED DESCRIPTION OF THE PREFERRED EMBODIMENTS

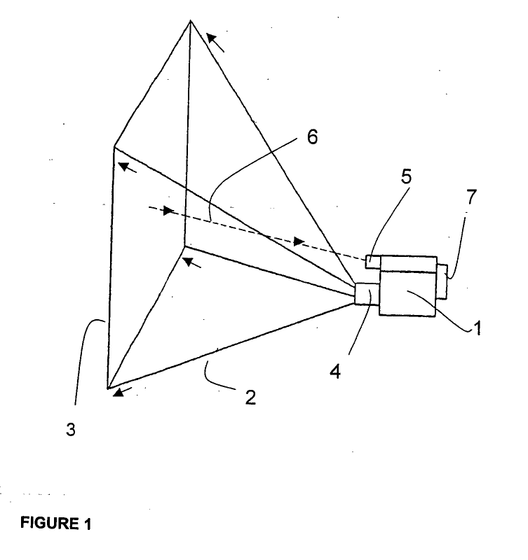

FIG. 1 shows a projector 1, whose projection beam 2 is directed at a projection surface (projection wall) 3. A sensor unit 5 designed as a spectrometer, integrated directly into the projector 1, is disposed above the projection lens 4, and said sensor unit captures the light 6 reflected by the projection surface 3, and transmits the captured values for the purpose of image data correction, with regard to the true color depiction, brightness, and color of the projection wall 3, as well as brightness and ambient light, for example, to a processor 7. In this context, the optic, not depicted in detail in FIG. 1, for capturing the light 6 reflected by the projection surface 3 in the sensor unit 5 could be an aspherical lens.

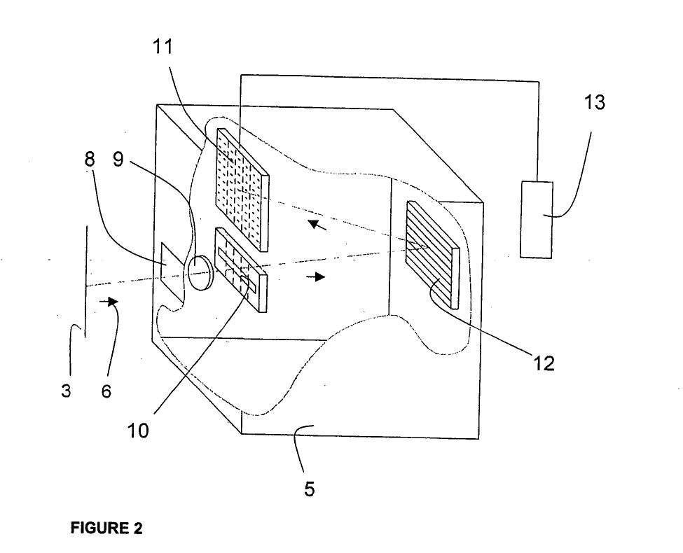

A complete sensor unit 5 for detecting the light 6 reflected by the projection surface 3 is shown in FIG. 2.

The light 6 reaches an entry gap 10 through a light entry window 8 and a lens 9. An imaging holographic grid 12 is provided to display the entry gap 10 on a detector unit 11, whose individual elements are arranged in matrix form (CCD, CMOS or PDA elements). To analyze the light 6 reflected by the projection surface 3, as well as to convert the values into correction settings of the projection beam path, the detector unit is connected to a processor 13.

1. Arrangement for correction of the visual depiction of image information on a projection surface, such as a projection wall, comprising a processor for the purpose of providing the image information, which is connected to a projector as well as a sensor unit for capturing image data, which can be captured by the processor and converted to correction data, wherein the sensor unit consists of at least one of a color sensor and a sensor for capturing geometric image data, and wherein the at least one of the color sensor and the sensor for capturing geometric image data is integrated into the projector.

2. Arrangement for correction of the visual depiction of image information according to claim 1, wherein for the purpose of capturing metering light, the sensor unit is oriented in at least one of the direction of the projection beam path and the direction of the light reflected by the project surface.

3. Arrangement for correction of the visual depiction of image information according to claim 2, wherein a spectrometer is provided for detecting the parameters of the true color depiction, brightness, and color of the projection wall, as well as of brightness and ambient light.

4. Arrangement for correction of the visual depiction of image information according to claim 3, wherein for detection of the metering light reflected by the projection surface, an aspherical lens is provided which is connected upstream from the sensor unit and located adjacent to the optic of the projection lens.

5. Arrangement for correction of the visual depiction of image information according to claim 3, wherein for detection of the metering light reflected by the projection surface, the sensor unit is arranged in the projection lens of the projector, wherein the metering light reaches the sensor unit through the optic of the projection lens.

6. Arrangement for correction of the visual depiction of image information according to claim 2, wherein a sensor with two-dimensional, matrix-like detector elements is provided for detection of the parameters of image sharpness and linear distortion.

7. Arrangement for correction of the visual depiction of image information according to claim 6, wherein the detector elements are CCD, CMOS or PDA elements.

8. Arrangement for correction of the visual depiction of image information on a projection surface, such as a projection wall, comprising a processor for the purpose of providing the image information, the processor connected to a projector and a sensor unit for capturing image data, which can be converted to correction data and wherein the sensor unit comprises a color sensor integrated into the projector.

9. Arrangement for correction of the visual depiction of image information according to claim 8, wherein the sensor unit is oriented in the direction of the projection beam path for capturing metering light.

10. Arrangement for correction of the visual depiction of image information according to claim 8, wherein the sensor unit is oriented in the direction of the light reflected by the project surface for capturing metering light.

11. Arrangement for correction of the visual depiction of image information according to claim 8, wherein the sensor unit further comprises a sensor for capturing geometric image data.

12. Arrangement for correction of the visual depiction of image information according to claim 8 further comprising a spectrometer.

13. Arrangement for correction of the visual depiction of image information according to claim 12, wherein the spectrometer detects at least one of: brightness, color of the projection wall, brightness and ambient light.

14. Arrangement for correction of the visual depiction of image information according to claim 12, wherein the spectrometer detects the parameters of the true color depiction, brightness, color of the projection wall, brightness and ambient light.

15. Arrangement for correction of the visual depiction of image information according to claim 8, wherein for detection of the metering light reflected by the projection surface, an aspherical lens is provided which is connected upstream from the sensor unit and located adjacent to the optic of the projection lens.

16. Arrangement for correction of the visual depiction of image information according to claim 8, wherein for detection of the metering light reflected by the projection surface the sensor unit is arranged in the projection lens of the projector and wherein the metering light reaches the sensor unit through the optic of the projection lens.

17. Arrangement for correction of the visual depiction of image information on a projection surface, such as a projection wall, the arrangement comprising a processor for the purpose of providing the image information, the processor connected to a projector and a sensor unit for capturing image data which can be converted to correction data and wherein the sensor unit comprises a sensor for capturing geometric image data integrated into the projector.

18. Arrangement for correction of the visual depiction of image information according to claim 17, wherein the sensor unit is oriented in the direction of the projection beam path for capturing metering light.

19. Arrangement for correction of the visual depiction of image information according to claim 17, wherein the sensor unit is oriented in the direction of the light reflected by the project surface for capturing metering light.

20. Arrangement for correction of the visual depiction of image information according to claim 17, wherein a sensor with two-dimensional, matrix-like detector elements is provided for detection of the parameters of image sharpness and linear distortion.

21. Arrangement for correction of the visual depiction of image information according to claim 20, wherein the detector elements are CCD, CMOS or PDA elements.

22. Arrangement for correction of the visual depiction of image information according to claim 8, wherein a sensor with two-dimensional, matrix-like detector elements is provided for detection of the parameters of image sharpness and linear distortion and wherein the detector elements are CCD, CMOS or PDA elements.
